(19) United States
(12) Patent Application Publication
(10) Pub. No.: US 2015/0002688 A1
(43) Pub. Date: Jan. 1, 2015

(54) AUTOMATED CAMERA ADJUSTMENT

(71) Applicants: James A. Baldwin, Palo Alto, CA (US); Richard S. Bell, Portland, OR (US); Anil Kumar, Chandler, AZ (US)

(72) Inventors: James A. Baldwin, Palo Alto, CA (US); Richard S. Bell, Portland, OR (US); Anil Kumar, Chandler, AZ (US)

(21) Appl. No.: 13/928,262

(22) Filed: Jun. 26, 2013

(51) Int. Cl. H04N 5/232

(52) U.S. Cl. CPC H04N 5/23203; H04N 5/23296
USPC 348/211.9

(57) ABSTRACT

In embodiments, apparatuses, methods and storage media are described that are associated with controlling production of images on a camera. In embodiments, a device with a camera, such as a content consumption device, may determine a current orientation of the camera and may adjust production of images from the camera to account for the orientation. The device may determine the orientation based on physical data, such as data from an accelerometer, compass, and/or gyroscope. the device may also determine the orientation from image data. The device may adjust production of images by either before capture, such as by physically adjusting the orientation of the camera, or after capture, such as by panning, tilting, and/or zooming captured images. Other embodiments may be described and claimed.

### TECHNICAL FIELD

The present disclosure relates to the field of data processing, in particular, to apparatuses, methods and systems associated with digital image processing.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Modern electronic devices, including devices for presentation of content and video game devices, increasingly utilize cameras and other image-capturing components (herein referred to generally as “cameras”) for their operation. For example, many modern devices utilize face and/or body recognition for user control, configuration settings, etc. However, because these cameras are oftentimes operated autonomously, they are rarely under control of a human. This lack of human interaction and supervision may mean that the camera image quality itself is not being supervised and corrected for. Thus, when cameras are improperly placed or otherwise set up, the quality of images taken by the camera may suffer. This issue may particularly present itself in devices, such as set-top-boxes, which have integrated cameras and which therefore do not offer as direct control over camera placement as other camera-equipped devices.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the Figures of the accompanying drawings.

FIG. 1 illustrates an example arrangement for content distribution and consumption, in accordance with various embodiments.

FIG. 2 illustrates an example arrangement for camera adjustment, in accordance with various embodiments.

FIG. 3 illustrates an example process for automated camera adjustment, in accordance with various embodiments.

FIG. 4 illustrates an example process for determining orientation of a camera, in accordance with various embodiments.

FIG. 5 illustrates an example process for adjusting images captured by a camera, in accordance with various embodiments.

FIG. 6 illustrates an example computing environment suitable for practicing various aspects of the present disclosure, in accordance with various embodiments.

FIG. 7 illustrates an example storage medium with instructions configured to enable an apparatus to practice various aspects of the present disclosure, in accordance with various embodiments.

### DETAILED DESCRIPTION

Embodiments described herein are directed to, for example, methods, computer-readable media, and apparatuses associated with adjustment of images taken with a camera. In embodiments, an orientation for a camera may be determined. The orientation may be determined, in various embodiments, with respect to one or more different axes. The orientation may be detected, in various embodiments, through the use of one or more physical orientation detection mechanisms, such as accelerometers, compasses, and/or gyroscopes. After the orientation is determined, adjustments may be made with respect to the capture of images from the camera to account for the detected orientation. In various embodiments, these adjustments may be made electronically to images after they are captured by the camera. In other embodiments, the camera may be physically adjusted to alter its orientation prior to capture of images. In various embodiments, techniques described herein may be used with respect to a camera associated with a content consumption device.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “logic” and “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

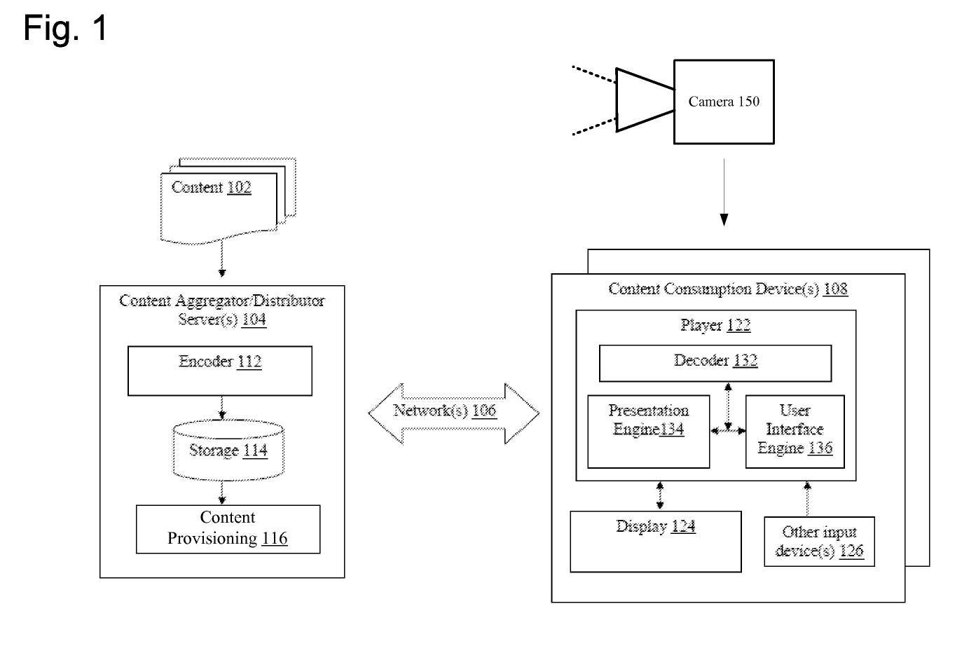

Referring now to FIG. 1, an arrangement 100 for content distribution and consumption, in accordance with various embodiments, is illustrated. As shown, in embodiments, arrangement 100 for distribution and consumption of content may include a number of content consumption devices 108 coupled with one or more content aggregator/distributor servers 104 via one or more networks 106. Content aggregator/distributor servers 104 may be configured to aggregate and distribute content to content consumption devices 108 for consumption, e.g., via one or more networks 106. In various embodiments, camera adjustment techniques described herein may be implemented in association with arrangement 100. In other embodiments, different arrangements, devices, and/or systems maybe used.

In embodiments, as shown, content aggregator/distributor servers 104 may include encoder 112, storage 114 and content provisioning 116, which may be coupled to each other as shown. Encoder 112 may be configured to encode content 102 from various content creators and/or providers 101, and storage 114 may be configured to store encoded content. Content provisioning 116 may be configured to selectively retrieve and provide encoded content to the various content consumption devices 108 in response to requests from the various content consumption devices 108. Content 102 may be media content of various types, having video, audio, and/or closed captions, from a variety of content creators and/or providers. Examples of content may include, but are not limited to, movies, TV programming, user created content (such as YouTube video, iReporter video), music albums/titles/pieces, and so forth. Examples of content creators and/or providers may include, but are not limited to, movie studios/distributors, television programmers, television broadcasters, satellite programming broadcasters, cable operators, online users, and so forth.

In various embodiments, for efficiency of operation, encoder 112 may be configured to encode the various content 102, typically in different encoding formats, into a subset of one or more common encoding formats. However, encoder 112 may be configured to nonetheless maintain indices or cross-references to the corresponding content in their original encoding formats. Similarly, for flexibility of operation, encoder 112 may encode or otherwise process each or selected ones of content 102 into multiple versions of different quality levels. The different versions may provide different resolutions, different bitrates, and/or different frame rates for transmission and/or playing. In various embodiments, the encoder 112 may publish, or otherwise make available, information on the available different resolutions, different bitrates, and/or different frame rates. For example, the encoder 112 may publish bitrates at which it may provide video or audio content to the content consumption device(s) 108. Encoding of audio data may be performed in accordance with, e.g., but are not limited to, the MP3 standard, promulgated by the Moving Picture Experts Group (MPEG). Encoding of video data may be performed in accordance with, e.g., but are not limited to, the H264 standard, promulgated by the International Telecommunication Unit (ITU) Video Coding Experts Group (VCEG). Encoder 112 may include one or more computing devices configured to perform content portioning, encoding, and/or transcoding, such as described herein.

Storage 114 may be temporal and/or persistent storage of any type, including, but are not limited to, volatile and non-volatile memory, optical, magnetic and/or solid state mass storage, and so forth. Volatile memory may include, but are not limited to, static and/or dynamic random access memory. Non-volatile memory may include, but are not limited to, electrically erasable programmable read-only memory, phase change memory, resistive memory, and so forth.

In various embodiments, content provisioning 116 may be configured to provide encoded content as discrete files and/or as continuous streams of encoded content. Content provisioning 116 may be configured to transmit the encoded audio/video data (and closed captions, if provided) in accordance with any one of a number of streaming and/or transmission protocols. The streaming protocols may include, but are not limited to, the Real-Time Streaming Protocol (RTSP). Transmission protocols may include, but are not limited to, the transmission control protocol (TCP), user datagram protocol (UDP), and so forth. In various embodiments, content provisioning 116 may be configured to provide media files that are packaged according to one or more output packaging formats.

Networks 106 may be any combinations of private and/or public, wired and/or wireless, local and/or wide area networks. Private networks may include, e.g., but are not limited to, enterprise networks. Public networks, may include, e.g., but is not limited to the Internet. Wired networks, may include, e.g., but are not limited to, Ethernet networks. Wireless networks, may include, e.g., but are not limited to, Wi-Fi, or 3G/4G networks. It would be appreciated that at the content distribution end, networks 106 may include one or more local area networks with gateways and firewalls, through which content aggregator/distributor server 104 communicate with content consumption devices 108. Similarly, at the content consumption end, networks 106 may include base stations and/or access points, through which consumption devices 108 communicate with content aggregator/distributor server 104. In between the two ends may be any number of network routers, switches and other networking equipment of the like. However, for ease of understanding, these gateways, firewalls, routers, switches, base stations, access points and the like are not shown.

In various embodiments, as shown, a content consumption device 108 may include player 122, display 124 and user input device(s) 126. Player 122 may be configured to receive streamed content, decode and recover the content from the content stream, and present the recovered content on display 124, in response to user selections/inputs from user input device(s) 126.

In various embodiments, in addition to other input device(s) 126, the content consumption device may also interact with a camera 150. In various embodiments, this camera 150 may include various devices, including separate or attached cameras, webcams, video and/or still cameras, etc. In various embodiments, the camera 150 may be physically attached to the content consumption device 108, such that its physical placement is directed by placement of the content consumption device 108. In other embodiments, the camera 150 may be incorporated into other deices, such as display 124. In yet other embodiments, the camera 150 may be free standing.

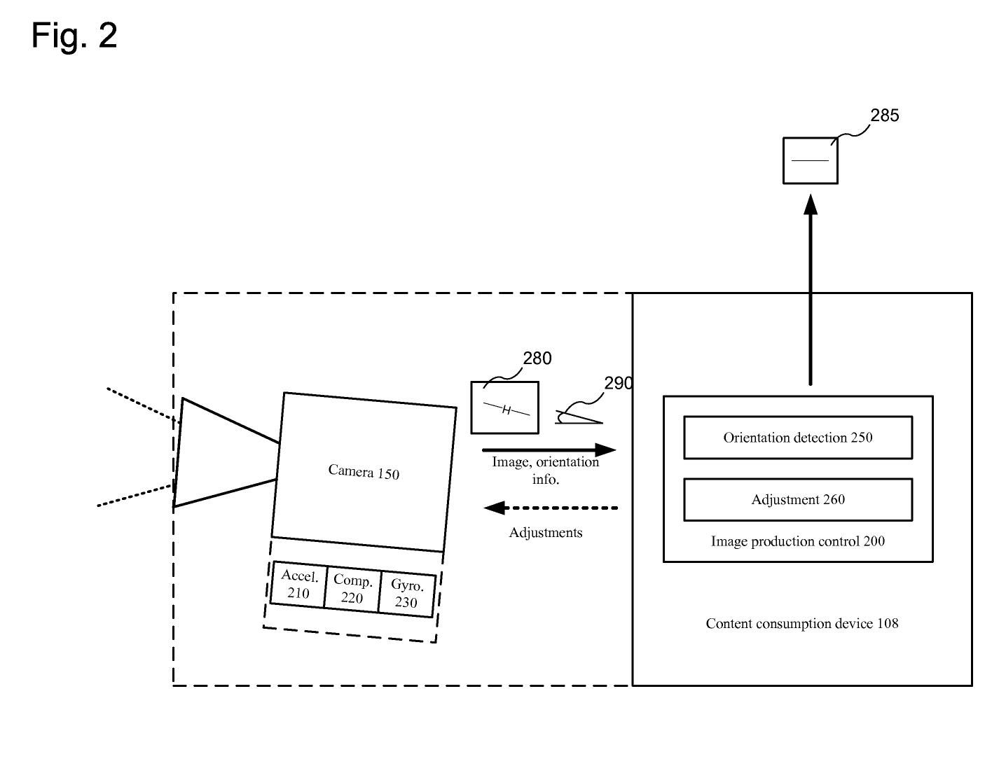

In various embodiments, the camera 150 may interact with an image production control module 200 (FIG. 2) of the content consumption device 108 to control production of images captured by the camera 150 to adjust for a detected orientation of the camera 150. More detail about image production control module 200 is described below. In other embodiments, control of camera 150 may be provided by devices other than the content consumption device 108 or may be provided by the camera 150 itself.

In some embodiments, the camera 150 may be configured to be adjustable, such as through manual repositioning, or through the use of mechanical actuators that are configured to change the position, pan, and/or tilt of the camera 150, such as in response to a command. In various embodiments, the camera 150 may be configured to provide a zooming feature, such as through relative movement of lenses within the camera 150, to allow for zooming in and out of an image. In some embodiments, the camera 150 may be relatively fixed, in that it may only be adjustable through placement of a body of the camera 150, and may not be otherwise adjustable.

In various embodiments, player 122 may include decoder 132, presentation engine 134 and user interface engine 136. Decoder 132 may be configured to receive streamed content, decode and recover the content from the content stream. Presentation engine 134 may be configured to present the recovered content on display 124, in response to user selections/inputs. In various embodiments, decoder 132 and/or presentation engine 134 may be configured to present audio and/or video content to a user that has been encoded using varying encoding control variable settings in a substantially seamless manner. Thus, in various embodiments, the decoder 132 and/or presentation engine 134 may be configured to present two portions of content that vary in resolution, frame rate, and/or compression settings without interrupting presentation of the content. User interface engine 136 may be configured to receive signals from user input device 126 that are indicative of the user selections/inputs from a user, and to selectively render a contextual information interface as described herein.

While shown as part of a content consumption device 108, display 124 and/or user input device(s) 126 may be stand-alone devices or integrated, for different embodiments of content consumption devices 108. For example, for a television arrangement, display 124 may be a stand alone television set, Liquid Crystal Display (LCD), Plasma and the like, while player 122 may be part of a separate set-top set, and user input device 126 may be a separate remote control (such as described below), gaming controller, keyboard, or another similar device. Similarly, for a desktop computer arrangement, player 122, display 124 and user input device(s) 126 may all be separate stand alone units. On the other hand, for a tablet arrangement, display 124 may be a touch sensitive display screen that includes user input device(s) 126, and player 122 may be a computing platform with a soft keyboard that also includes one of the user input device(s) 126. Further, display 124 and player 122 may be integrated within a single form factor. Similarly, for a smartphone arrangement, player 122, display 124 and user input device(s) 126 may be likewise integrated.

Referring now to FIG. 2, an example arrangement for camera adjustment is shown in accordance with various embodiments. As illustrated, in various embodiments, the camera 150 may be coupled to the content consumption device 108. In alternative embodiments, the camera 150 may be incorporated into the content consumption device 108, as indicated by the dashed line projecting from content consumption device 108. As discussed above, in various embodiments, the camera 150 may include various still or video cameras. In various embodiments, the camera 150 may be fixed (such as by being fixed in the content consumption device 108) or moveable. Additionally, in various embodiments, if the camera 150 is equipped to be moveable, in various embodiments, the camera 150 may be equipped to be manually manipulated and moved, and/or may be equipped to be moved through one or more actuators (not illustrated) as may be understood.

In various embodiments, and as illustrated, the camera 150 may be positioned such that the camera 150 is not lined up as would otherwise be preferred. In such a scenario, images produced by the camera 150 may be skewed in one or more directions, such as the example image 280, which shows a horizon that is skewed by a few degrees. (It may be noted that the illustrated physical orientation example of camera 150 does not precisely line up with the example image 280; it may be appreciated these are general examples of each and are not meant to imply any precise limiting relationship between the two.)

In various embodiments, the camera 150 may be coupled to one or more physical orientation detectors 210-230, such as, for example, accelerometer 210, compass 220, and/or gyroscope 230 may be coupled to the camera 150 in order to detect the physical orientation of the camera 150 (illustrated in FIG. 2 as orientation information 290). In various embodiments, the physical orientation detectors 210-230 may be configured to provide orientation information 290 about the physical orientation of the camera 150 in various axes. For example, the physical orientation detectors 210-230 may be configured to provide orientation information for the camera around a horizontal axis running through a center point of images captured by the camera 150 (e.g. a forward-backward axis). In another example, the physical orientation detectors 210-230 may be configured to provide orientation information for the camera around a horizontal axis cutting across images captured by the camera (e.g. a left-right axis). In another example, the physical orientation detectors 210-230 may be configured to provide orientation information for the camera around a vertical axis orthogonal to the ground (e.g. an up-down axis). In various embodiments the orientation information 290 may include an angle of a physical orientation detector 210-230 (and therefore the camera 150) relative to a particular axis, as illustrated in the example of FIG. 2. In various embodiments, other measures of physical orientation may be utilized.

In various embodiments, one or more of the physical orientation detectors may be physically incorporated in the camera 150. In other embodiments, one or more physical orientation detectors may not be physically incorporated into the camera, but may instead be physically incorporated into a device that also incorporates the camera, such as content consumption device 108. In various embodiments, the one or more physical orientation detectors may be physically connected in some manner to the camera 150 so that information about the physical orientation of the physical orientation detectors 210-230 may be imputed to the physical orientation of the camera 150. For example, if the camera 150 is incorporated in the content consumption device 108, the physical orientation detectors 210-230 may be incorporated elsewhere in the content consumption device 108 without necessarily being incorporated into the camera 150.

In various embodiments, the image production control module 200 may be configured to control production of one or more images from the camera 150 to produce one or more images that account for the orientation of the camera 150, such as adjusted image 285. In various embodiments, the image production control module 200 may include an orientation detection module 250, which may be configured to detect an orientation for the camera 150. In various embodiments, the orientation detection module 250 may be configured to detect an orientation for the camera 250 based on the orientation information 290. In other embodiments, the orientation detection module 250 may be configured to detect an orientation for the camera 250 based on one or more images 280, such as by detecting an offset of a line that is known to follow a particular axis.

In various embodiments, the image production control module 200 may also include an adjustment module 260, which may be configured to adjust production of one or more images from the camera 150 to account for the detected orientation. In various embodiments, the adjustment module 260 may be configured to perform electronic adjustment of images after they are captured. In other embodiments, the adjustment module 260 may be configured to perform physical adjustment to the orientation of the camera 150 itself in order to account for the orientation of the camera. Particular embodiments of detection of orientation and adjustment are described below.

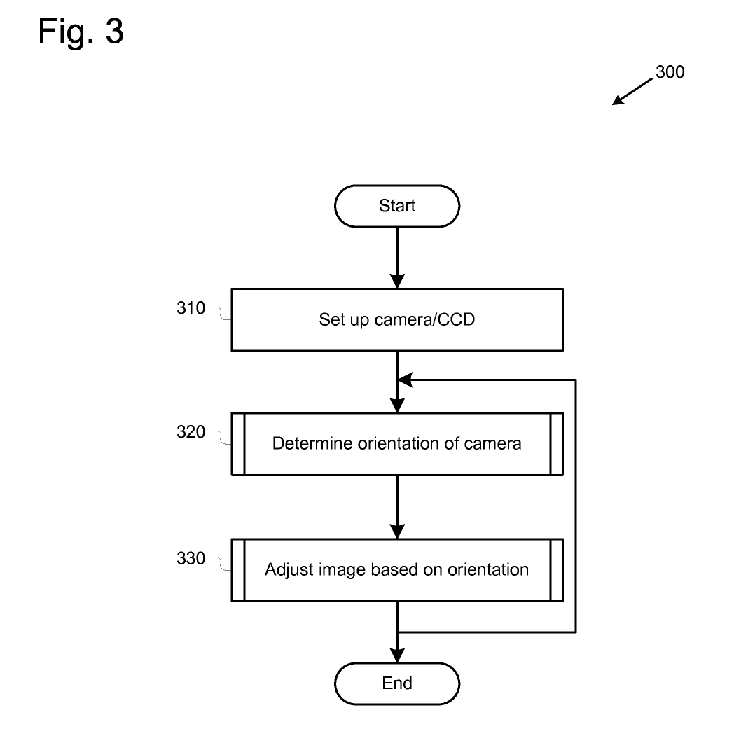

Referring now to FIG. 3, an example process 300 or automated camera adjustment is illustrated in accordance with various embodiments. While FIG. 3 illustrates particular example operations for process 300, in various embodiments, process 300 may include additional operations, omit illustrated operations, and/or combine illustrated operations. In various embodiments, process 300 may be performed by the image production control module 200 of the content consumption device 108; however, in alternative embodiments, other arrangements of modules and devices may be utilized, such as discussed above. The process may begin at operation 310, where a user may set up the camera 150 and/or content consumption device 108. in various embodiments, the set up may include placement of the camera 150 and/or content consumption device—the camera and/or content consumption device 108 may, in various embodiments, be placed such that images captured by the camera 150 are displaced from a preferred orientation with respect to one or more axes.

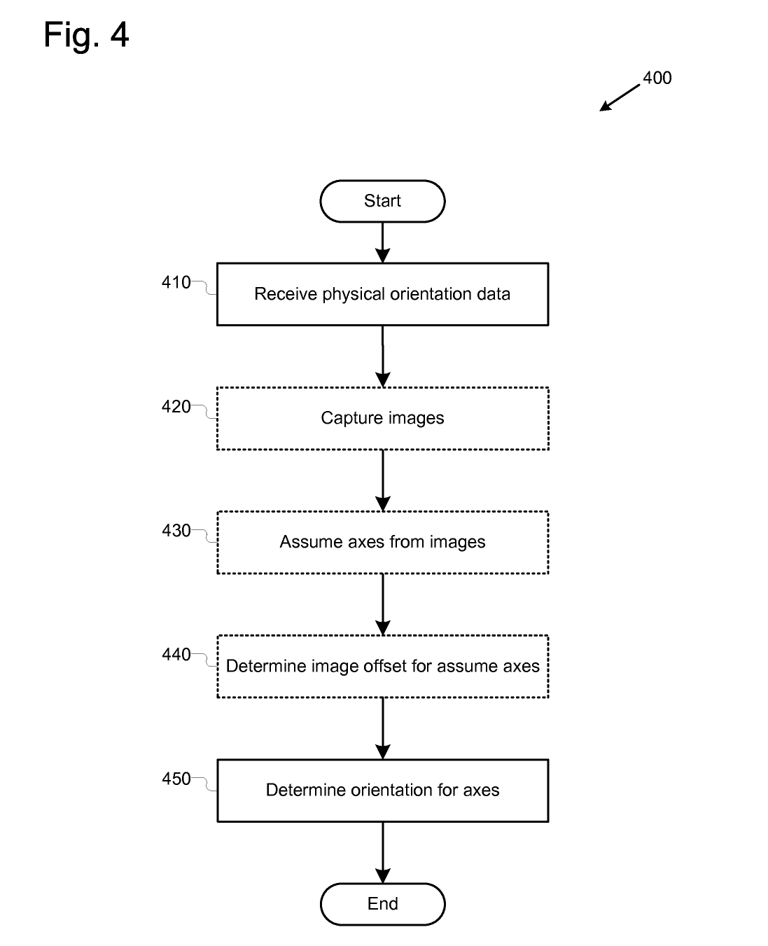

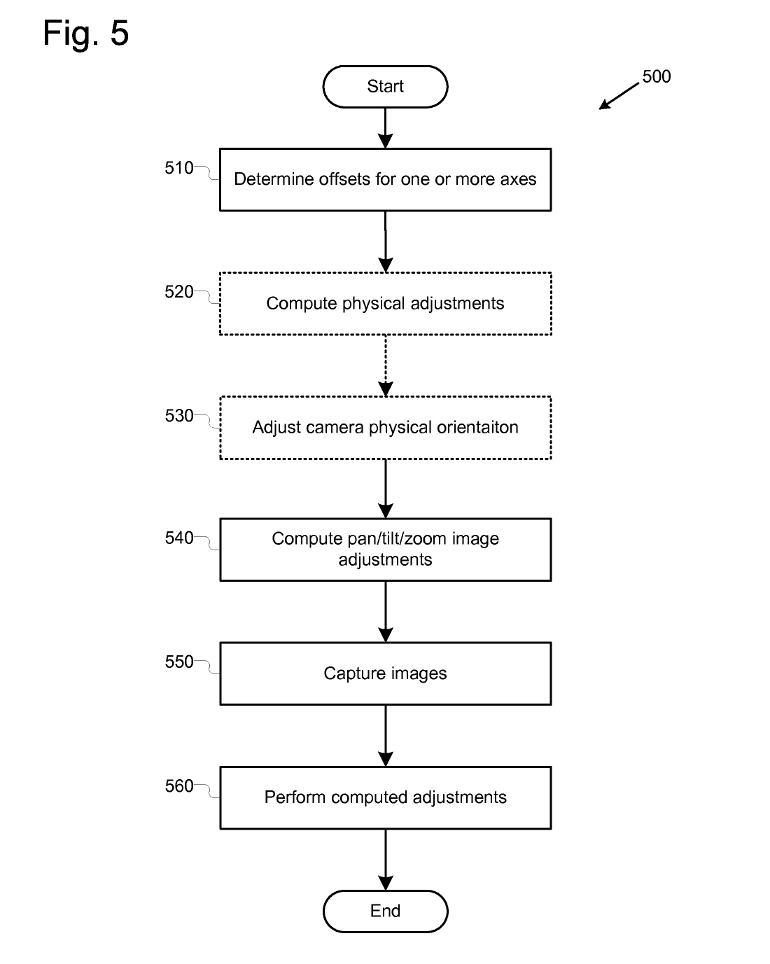

Next, at operation 320, the image production control module 200, and in particular the orientation detection module 250 of the image production control module 200 may detect a current orientation for the camera 150. Particular implementations of operation 320 may be described below with reference to process 400 of FIG. 4. Next, at operation 330, the image production control module 200, and in particular the adjustment module 260 of the image production control module 200 may adjust production of one or more images of the camera 150. Particular implementations of operation 330 may be described below with reference to process 500 of FIG. 5. The process may then repeat through operations 320 and 330 such that images captured by the camera 150 are continuously accounted for. In some embodiments, alternatively, the process may then end.

Referring now to FIG. 4, an example process 400 determining orientation of the camera 150 is illustrated in accordance with various embodiments. While FIG. 4 illustrates particular example operations for process 400, in various embodiments, process 400 may include additional operations, omit illustrated operations, and/or combine illustrated operations. In various embodiments, process 400 may be performed by the orientation detection module 250 of the image production control module 200. The process may begin at operation 410, where the orientation detection module 250 may receive physical orientation information from the one or more physical orientation detectors 210-230. In various embodiments, this physical orientation information may include an offset between an preferred axis and a current axis of the camera 150. In various embodiments, this offset may be measured, such as in degrees of an angle.

Next, at operations 420-440, the orientation detection module 250 may perform additional detection based on captured images. In various embodiments, operations 420-440 may not be performed, and the orientation detection module 250 may rely on the physical orientation information received at operation 410. However, if operations 420-440 are performed, then at operation 420, the orientation detection module 250 may receive one or more images captured by the camera 150. In various embodiments, these images may capture objects or features that are known (or can be assumed) to fall along a particular axis.

Next, at operation 430, the orientation detection module 250 may assume one or more axes based on the captured images. For example, in some scenarios, the camera 150 may capture an image of a horizon, which can be assumed by the orientation detection module 250 to fall along a left-right axis. Similarly, in some scenarios, the camera 150, when capturing an image of a room, may capture an image of a table or sofa that may be assumed by the orientation detection module 250 to be horizontal. In yet another example, the camera 150 may continuously capture images of a person. If that person frequently is found in an upright standing position, the orientation detection module 250 may assume this to be indicative of a vertical axis. In yet another example, a dedicated axis guide (such as a crosshairs) may be displayed in view of the camera 150 and may be understood by the orientation detection module 250 to represent known axes. Next, at operation 440, the orientation detection module 250 may determine an image-based offset for the assumed axes.

Next, at operation 450, the orientation detection module 250 may determine an orientation for one or more axes. In various embodiments, at operation 450 orientation may be determined for one, two, or three axes, or for other forms of position/orientation measurement. In various embodiments, the orientation detection module 250 may simply utilize the direct physical orientation data received at operation 410. In other embodiments, the orientation detection module 250 may combine offsets determined at operation 440 with these direct physical orientation data measurements to determine an orientation. Thus, if multiple orientation values are received for an axis, such as by multiple physical orientation detectors and/or by determinations of orientation based on images, the values may be combined, such as by averaging or other mathematical means. The process may then end.

Referring now to FIG. 5, an example process 500 for adjusting images captured by the camera is illustrated in accordance with various embodiments. While FIG. 5 illustrates particular example operations for process 500, in various embodiments, process 500 may include additional operations, omit illustrated operations, and/or combine illustrated operations. In various embodiments, process 500 may be performed by the adjustment module 260 of the image production control module 200. The process may begin at operation 510, where the adjustment module 260 may determine offsets for one or more axes to account for the orientation of the camera 150 that was determined during process 400. In various embodiments, the offsets may be identical to the orientation determined during process 400 on a per-axis. In some embodiments the offsets may be less than the orientation determined at operation 400, such as if the determined orientation is so far off of an axis that it cannot be completely corrected for by the adjustment module 260.

Next, at operations 520 and 530, the adjustment module 260 may control physical adjustments to the camera 150 based on the determined offsets. In various embodiments, operations 520 and 530 may not be performed, and the adjustment module 250 may perform only electronic adjustment of captured images. However, if operations 520 and 530 are performed, then at operation 520, the adjustment module 260 may compute one or more physical adjustments to be made to the camera 150 and, at operation 530, the adjustment module 260 may physically adjust the camera 150 accordingly. In various embodiments, these physical adjustments may include tilting, panning, rotating, or other motion of a body of the camera 150, such as by mechanical actuators attached to the camera 150. In other embodiments, physical adjustments may include zooming of the camera 150, such as by movement of one or more lenses in camera 150, as may be understood.

Next, at operation 540, the adjustment module 260 may compute one or more electronic pan, tilt, or zoom image adjustments that may be performed to account for the determined orientation of the camera 150. In various embodiments, these computed adjustments may correct, in whole or in part, for the determined orientation of the camera 150. For example, if it is determined that the camera 150 has a tilt of 10 degrees counter-clockwise, at operation 540, the adjustment module 260 may compute a 10 degree clockwise adjustment to images captured by the camera 150.

Next, at operation 550, the camera 150 may capture one or more images. Then, at operation 560, these images may be adjusted electronically based on the computed adjustments of operation 540. It may be recognized that, in some embodiments, the adjusted images may be further altered, such as by cropping the adjusted images to produce consistency of size and/or shape. The process may then end.

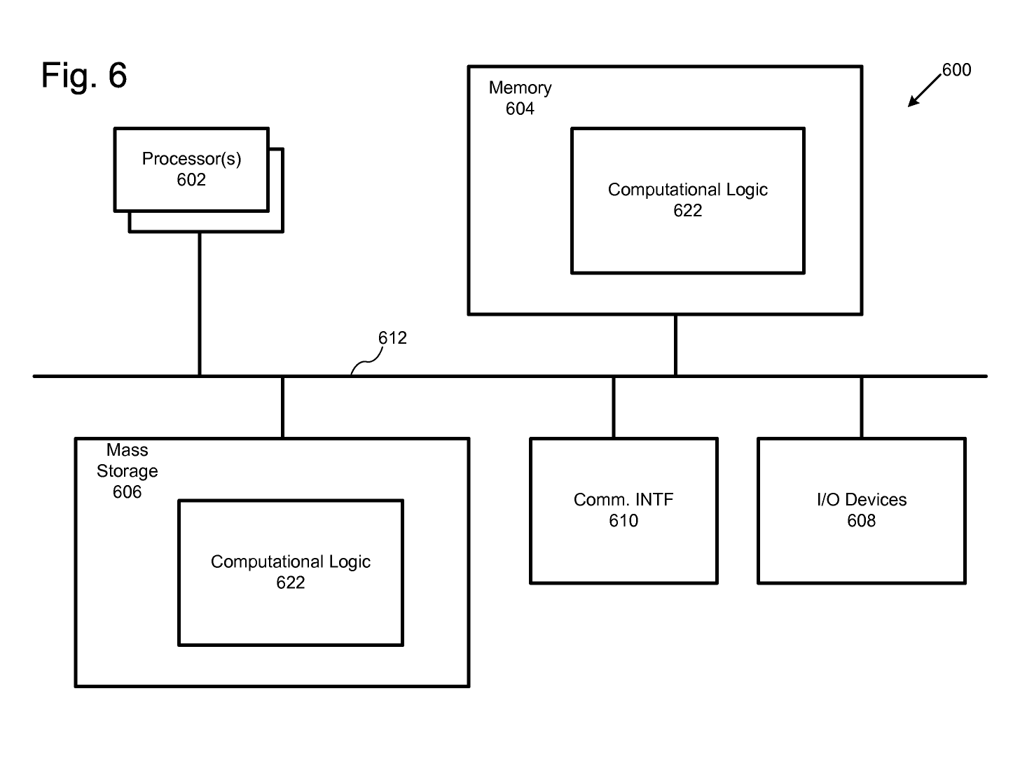

Referring now to FIG. 6, an example computer suitable for practicing various aspects of the present disclosure, including processes of FIGS. 3-5, is illustrated in accordance with various embodiments. As shown, computer 600 may include one or more processors or processor cores 602, and system memory 604. For the purpose of this application, including the claims, the terms “processor” and “processor cores” may be considered synonymous, unless the context clearly requires otherwise. Additionally, computer 600 may include mass storage devices 606 (such as diskette, hard drive, compact disc read only memory (CD-ROM) and so forth), input/output devices 608 (such as display, keyboard, cursor control, remote control, gaming controller, image capture device, and so forth) and communication interfaces 610 (such as network interface cards, modems, infrared receivers, radio receivers (e.g., Bluetooth), and so forth). The elements may be coupled to each other via system bus 612, which may represent one or more buses. In the case of multiple buses, they may be bridged by one or more bus bridges (not shown).

Each of these elements may perform its conventional functions known in the art. In particular, system memory 604 and mass storage devices 606 may be employed to store a working copy and a permanent copy of the programming instructions implementing the operations associated with content consumption device 108, e.g., operations associated with camera control such as shown in FIGS. 3-5. The various elements may be implemented by assembler instructions supported by processor(s) 602 or high-level languages, such as, for example, C, that can be compiled into such instructions.

The permanent copy of the programming instructions may be placed into permanent storage devices 606 in the factory, or in the field, through, for example, a distribution medium (not shown), such as a compact disc (CD), or through communication interface 610 (from a distribution server (not shown)). That is, one or more distribution media having an implementation of the agent program may be employed to distribute the agent and program various computing devices.

The number, capability and/or capacity of these elements 610-612 may vary, depending on whether computer 600 is used as a content aggregator/distributor server 104 or a content consumption device 108 (e.g., a player 122). Their constitutions are otherwise known, and accordingly will not be further described.

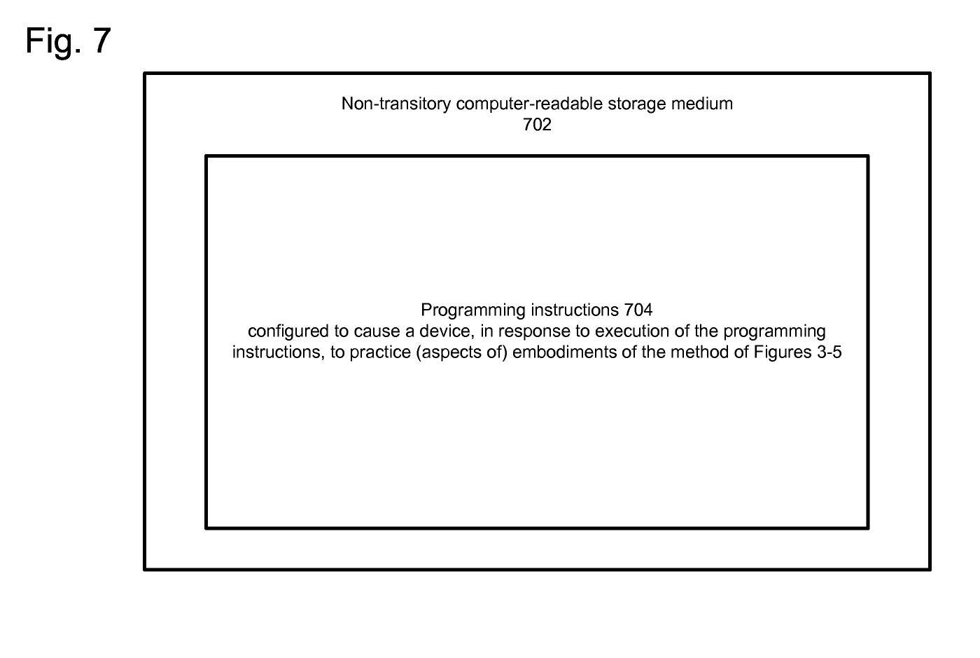

FIG. 7 illustrates an example least one computer-readable storage medium 702 having instructions configured to practice all or selected ones of the operations associated with content consumption device 108, e.g., operations associated with camera control, earlier described, in accordance with various embodiments. As illustrated, least one computer-readable storage medium 702 may include a number of programming instructions 704. Programming instructions 704 may be configured to enable a device, e.g., computer 600, in response to execution of the programming instructions, to perform, e.g., various operations of processes of FIGS. 3-5, e.g., but not limited to, to the various operations performed to perform determination of frame alignments. In alternate embodiments, programming instructions 704 may be disposed on multiple least one computer-readable storage media 702 instead.

Referring back to FIG. 6, for one embodiment, at least one of processors 602 may be packaged together with computational logic 622 configured to practice aspects of processes of FIGS. 3-5. For one embodiment, at least one of processors 602 may be packaged together with computational logic 622 configured to practice aspects of processes of FIGS. 3-5 to form a System in Package (SiP). For one embodiment, at least one of processors 602 may be integrated on the same die with computational logic 622 configured to practice aspects of processes of FIGS. 3-5. For one embodiment, at least one of processors 602 may be packaged together with computational logic 622 configured to practice aspects of processes of FIGS. 3-5 to form a System on Chip (SoC). For at least one embodiment, the SoC may be utilized in, e.g., but not limited to, a computing tablet.

Various embodiments of the present disclosure have been described. These embodiments include, but are not limited to, those described in the following paragraphs.

Example 1 includes one or more computer-readable storage media including a plurality of instructions configured to cause a computing device, in response to execution of the instructions by the computing device, to control production of images from a camera. The instructions may cause the computing device to determine a current orientation of the camera and adjust production of one or more images from the camera to account for the current orientation.

Example 2 may include the computer-readable media of Example 1, wherein determine a current orientation may include determine a current orientation relative to an axis.

Example 3 may include the computer-readable media of Example 2, wherein determine a current orientation may includes determine a current orientation with respect to a horizontal axis running through a center of an image captured by the camera.

Example 4 may include the computer-readable media of Example 2, wherein determine a current orientation may include determine a current orientation with respect to a vertical axis of the camera.

Example 5 may include the computer-readable media of Example 2, wherein determine a current orientation may include determine a current orientation with respect to a horizontal axis of the camera.

Example 6 may include the computer-readable media of Example 2, wherein determine a current orientation may include determine an offset value describing a difference between a current orientation and a preferred position relative to the axis and adjust production of one or more images may include adjust one or more images to account for the offset value.

Example 7 may include the computer-readable media of any of Examples 1-6, wherein adjust production of one or more images may include tilt one or more images taken by the camera.

Example 8 may include the computer-readable media of any of Examples 1-6, wherein adjust production of one or more images may include pan one or more images taken by the camera.

Example 9 may include the computer-readable media of any of Examples 1-6, wherein adjust production of one or more images may include zoom in or out one or more images taken by the camera.

Example 10 may include the computer-readable media of any of Examples 1-6, wherein adjust one or more images may include electronically adjust one or more images after capture.

Example 11 may include the computer-readable media of any of Examples 1-6, wherein adjust one or more images may include direct physical adjustment the current orientation of the camera prior to capture of images.

Example 12 may include the computer-readable media of any of Examples 1-6, wherein the camera may include a still camera.

Example 13 may include the computer-readable media of any of Examples 1-6, wherein the camera may include a video camera.

Example 14 may include the computer-readable media of any of Examples 1-6, wherein determine a current orientation may include physically detect a current orientation of the camera.

Example 15 may include the computer-readable media of Example 14, wherein physically detect a current orientation of the camera may include detect a current orientation based on data from an accelerometer.

Example 16 may include the computer-readable media of Example 14, wherein physically detect a current orientation of the camera may include detect a current orientation based on data from a compass.

Example 17 may include the computer-readable media of Example 14, wherein physically detect a current orientation of the camera may include detect a current orientation based on data from a gyroscope.

Example 18 may include an apparatus configured to control production of images. The apparatus may include: a camera, one or more computing processors coupled to the camera, an orientation determination module configured to operate on the one or more computing processors to determine a current orientation of the camera, and an adjustment module configured to operate on the one or more computing processors to adjust production of one or more images from the camera to account for the current orientation.

Example 19 may include the apparatus of Example 18, wherein determine a current orientation may include determine a current orientation along an axis.

Example 20 may include the apparatus of Example 19, wherein determine a current orientation may include determine a current orientation with respect to a horizontal axis running through a center of an image captured by the camera.

Example 21 may include the apparatus of Example 19, wherein determine a current orientation may include determine a current orientation with respect to a vertical axis of the camera.

Example 22 may include the apparatus of Example 19, wherein determine a current orientation may include determine a current orientation with respect to a horizontal axis of the camera.

Example 23 may include the apparatus of Example 19, wherein:

determine a current orientation may include determine an offset value describing a difference between a current orientation and a preferred position relative to the axis; and

adjust production of one or more images may include adjust one or more images to account for the offset value.

Example 24 may include the apparatus of any of Examples 18-23, wherein adjust production of one or more images may include tilt one or more images taken by the camera.

Example 25 may include the apparatus of any of Examples 18-23, wherein adjust production of one or more images may include pan one or more images taken by the camera.

Example 26 may include the apparatus of any of Examples 18-23, wherein adjust production of one or more images may include zoom one or more images taken by the camera.

Example 27 may include the apparatus of any of Examples 18-23, wherein adjust one or more images may include electronically adjust one or more images after capture.

Example 28 may include the apparatus of any of Examples 18-23, wherein:

the apparatus may further include one or more mechanical actuators configured to physically adjust the current orientation of the camera; and

adjust one or more images may include physically adjust the current orientation of the camera prior to capture of images.

Example 29 may include the apparatus of any of Examples 18-23, wherein the camera may include a still camera.

Example 30 may include the apparatus of any of Examples 18-23, wherein the camera may include a video camera.

Example 31 may include the apparatus of any of Examples 18-23, wherein determine a current orientation may include physically detect a current orientation of the camera.

Example 32 may include the apparatus of Example 31, wherein physically detect a current orientation of the camera may include detect a current orientation based on data from an accelerometer.

Example 33 may include the apparatus of Example 31, wherein physically detect a current orientation of the camera may include detect an orientation based on data from a compass.

Example 34 may include the apparatus of Example 31, wherein physically detect a current orientation of the camera may include detect an orientation based on data from a gyroscope.

Example 35 may include a computer-implemented method for controlling production of images. The method may including determining, by a computing device, a current orientation of a camera; and adjusting, by the computing device, production of one or more images from the camera to account for the current orientation.

Example 36 may include the method of Example 35, wherein determining a current orientation may include determining a current orientation relative an axis.

Example 37 may include the method of Example 36, wherein determining a current orientation may include determining a current orientation with respect to a horizontal axis running through a center of an image captured by the camera.

Example 38 may include the method of Example 36, wherein determining a current orientation may include determining a current orientation with respect to a vertical axis of the camera.

Example 39 may include the method of Example 36, wherein determining a current orientation may include determining a current orientation with respect to a horizontal axis of the camera.

Example 40 may include the method of Example 36, wherein determining a current orientation may include determining an offset value describing a difference between a current orientation and a preferred position relative to the axis and adjusting one or more images may include adjusting one or more images to account for the offset value.

Example 41 may include the method of any of Examples 35-40, wherein adjusting production of one or more images may include tilting one or more images taken by the camera.

Example 42 may include the method of any of Examples 35-40, wherein adjusting production of one or more images may include panning one or more images taken by the camera.

Example 43 may include the method of any of Examples 35-40, wherein adjusting production of one or more images may include zooming one or more images taken by the camera.

Example 44 may include the method of any of Examples 35-40, wherein adjusting production of one or more images may include electronically adjusting one or more images after capture.

Example 45 may include the method of any of Examples 35-40, wherein adjusting production of one or more images may include directing physical adjustment the current orientation of the camera prior to capture of the one or more images.

Example 46 may include the method of any of Examples 35-40, wherein the camera may include a still camera.

Example 47 may include the method of any of Examples 35-40, wherein the camera may include a video camera.

Example 48 may include the method of any of Examples 35-40, wherein determining a current orientation may include physically detecting a current orientation of the camera.

Example 49 may include the method of Example 48, wherein physically detecting a current orientation of the camera may include detecting a current orientation based on data from an accelerometer.

Example 50 may include the method of Example 48, wherein physically detecting a current orientation of the camera may include detecting a current orientation based on data from a compass.

Example 51 may include the method of Example 48, wherein physically detecting a current orientation of the camera may include detecting a current orientation based on data from a gyroscope.

Example 52 may include an apparatus for controlling production of images from a camera. The apparatus may include a camera, means for determining a current orientation of the camera, and means for adjusting production of one or more images from the camera to account for the current orientation.

Example 53 may include the apparatus of Example 52, wherein means for determining a current orientation may include means for determining a current orientation relative to an axis.

Example 54 may include the apparatus of Example 53, wherein means for determining a current orientation may include means for determining a current orientation with respect to a horizontal axis running through a center of an image captured by the camera.

Example 55 may include the apparatus of Example 53, wherein means for determining a current orientation may include means for determining a current orientation with respect to a vertical axis of the camera.

Example 56 may include the apparatus of Example 53, wherein means for determining a current orientation may include means for determining a current orientation with respect to a horizontal axis of the camera.

Example 57 may include the apparatus of Example 53, wherein: means for determining a current orientation may include means for determining an offset value describing a difference between a current orientation and a preferred position relative to the axis and means for adjusting one or more images may include means for adjusting one or more images to account for the offset value.

Example 58 may include the apparatus of any of Examples 52-57, wherein means for adjusting production of one or more images may include means for tilting one or more images taken by the camera.

Example 59 may include the apparatus of any of Examples 52-57, wherein means for adjusting production of one or more images may include means for panning one or more images taken by the camera.

Example 60 may include the apparatus of any of Examples 52-57, wherein means for adjusting production of one or more images may include means for zooming one or more images taken by the camera.

Example 61 may include the apparatus of any of Examples 52-57, wherein means for adjusting one or more images may include means for electronically adjusting one or more images after capture.

Example 62 may include the apparatus of any of Examples 52-57, wherein means for adjusting one or more images may include means for physically adjusting a current orientation of the camera prior to capture of images.

Example 63 may include the apparatus of any of Examples 52-57, wherein the camera may include a still camera.

Example 64 may include the apparatus of any of Examples 52-57, wherein the camera may include a video camera.

Example 65 may include the apparatus of any of Examples 52-57, wherein means for determining a current orientation may include physically detecting a current orientation of the camera.

Example 66 may include the apparatus of Example 65, wherein physically detecting a current orientation of the camera may include detecting a current orientation based on data from an accelerometer.

Example 67 may include the apparatus of Example 65, wherein physically detecting a current orientation of the camera may include detecting a current orientation based on data from a compass.

Example 68 may include the apparatus of Example 65, wherein physically detecting a current orientation of the camera may include detecting a current orientation based on data from a gyroscope.

Computer-readable media (including least one computer-readable media), methods, apparatuses, systems and devices for performing the above-described techniques are illustrative examples of embodiments disclosed herein. Additionally, other devices in the above-described interactions may be configured to perform various disclosed techniques.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. One or more computer-readable storage media comprising a plurality of instructions configured to cause a computing device, in response to execution of the instructions by the computing device, to control production of images from a camera by causing the computing device to:
determine a current orientation of the camera; and
adjust production of one or more images from the camera to account for the current orientation.

2. The computer-readable media of claim 1, wherein determine a current orientation comprises determine a current orientation relative to an axis.

3. The computer-readable media of claim 2, wherein determine a current orientation comprises determine a current orientation with respect to one or more of a horizontal axis running through a center of an image captured by the camera, a vertical axis of the camera, or a horizontal axis of the camera.

4. The computer-readable media of claim 2, wherein:
determine a current orientation comprises determine an offset value describing a difference between a current orientation and a preferred position relative to the axis; and
adjust production of one or more images comprises adjust one or more images to account for the offset value.

5. The computer-readable media of claim 1, wherein adjust production of one or more images comprises one or more of tilt one or more images taken by the camera, pan one or more images taken by the camera, or zoom in or out one or more images taken by the camera.

6. The computer-readable media of claim 1, wherein adjust one or more images comprises electronically adjust one or more images after capture.

7. The computer-readable media of claim 1, wherein adjust one or more images comprises direct physical adjustment the current orientation of the camera prior to capture of images.

8. The computer-readable media of claim 1, wherein the camera comprises a still camera or a video camera.

9. The computer-readable media of claim 1, wherein determine a current orientation comprises physically detect a current orientation of the camera.

10. The computer-readable media of claim 13, wherein physically detect a current orientation of the camera comprises detect a current orientation based on data from one or more of an accelerometer, a compass, or a gyroscope.

11. An apparatus configured to control production of images, the apparatus comprising:
a camera;
one or more computing processors coupled to the camera;
an orientation determination module configured to operate on the one or more computing processors to determine a current orientation of the camera; and
an adjustment module configured to operate on the one or more computing processors to adjust production of one or more images from the camera to account for the current orientation.

12. The apparatus of claim 11, wherein determine a current orientation comprises determine a current orientation with respect to one or more of a horizontal axis running through a center of an image captured by the camera, a vertical axis of the camera, or a horizontal axis of the camera.

13. The apparatus of claim 11, wherein:
determine a current orientation comprises determine an offset value describing a difference between a current orientation and a preferred position relative to the axis; and
adjust production of one or more images comprises adjust one or more images to account for the offset value.

14. The apparatus of claim 11, wherein adjust production of one or more images comprises one or more of tilt one or more images taken by the camera, pan one or more images taken by the camera, or zoom one or more images taken by the camera.

15. The apparatus of claim 11, wherein determine a current orientation comprises physically detect a current orientation of the camera based on data from one or more of an accelerometer, a compass, or a gyroscope.

16. A computer-implemented method for controlling production of images, the method comprising:
determining, by a computing device, a current orientation of a camera; and
adjusting, by the computing device, production of one or more images from the camera to account for the current orientation.

17. The method of claim 16, wherein determining a current orientation comprises determining a current orientation with respect to one or more of a horizontal axis running through a center of an image captured by the camera, a vertical axis of the camera, or a horizontal axis of the camera.

18. The method of claim 16, wherein:
determining a current orientation comprises determining an offset value describing a difference between a current orientation and a preferred position relative to the axis; and
adjusting one or more images comprises adjusting one or more images to account for the offset value.

19. The method of claim 16, wherein adjusting production of one or more images comprises one or more of tilting one or more images taken by the camera, panning one or more images taken by the camera, or zooming one or more images taken by the camera.

20. The method of claims 16, wherein determining a current orientation comprises physically detecting a current orientation of the camera based on data from one or more of an accelerometer, a compass, or a gyroscope.

21. A apparatus for controlling production of images from a camera, the apparatus comprising:
a camera;
means for determining a current orientation of the camera; and
means for adjusting production of one or more images from the camera to account for the current orientation.

22. The apparatus of claim 21, wherein means for determining a current orientation comprises means for determining a current orientation with respect to one or more of a horizontal axis running through a center of an image captured by the camera, a vertical axis of the camera, or a horizontal axis of the camera.

23. The apparatus of claim 21, wherein:
means for determining a current orientation comprises means for determining an offset value describing a difference between a current orientation and a preferred position relative to the axis; and
means for adjusting one or more images comprises means for adjusting one or more images to account for the offset value.

24. The apparatus of claim 21, wherein means for adjusting production of one or more images comprises one or more of means for tilting one or more images taken by the camera, means for panning one or more images taken by the camera, or means for zooming one or more images taken by the camera.

25. The apparatus of claim 21, wherein means for determining a current orientation comprises physically detecting a current orientation of the camera based on data from one or more of an accelerometer, a compass, or a gyroscope.
